(19) United States
(12) Patent Application Publication
(10) Pub. No.: US 2020/0387990 A1
(43) Pub. Date: Dec. 10, 2020

(54) SYSTEMS AND METHODS FOR PERFORMING AUTOMATED FEEDBACK ON POTENTIAL REAL ESTATE TRANSACTIONS

(71) Applicant: REAL ESTATE EQUITY EXCHANGE INC., SAN FRANCISCO, CA (US)

(72) Inventors: BRAD LOOKABAUGH, OAKLAND, CA (US); JOHN BRODIE GAY, SAN FRANSISCO, CA (US)

(21) Appl. No.: 16/770,772

(22) PCT Filed: Dec. 7, 2018
(86) PCT No.: PCT/US18/64376

§ 371 Date: Jun. 8, 2020

Related U.S. Application Data
(60) Provisional application No. 62/596,526, filed on Dec. 8, 2017.

(51) Int. Cl. G06Q 50/16; G06Q 40/06; G06Q 40/02; G06F 16/2453

(52) U.S. Cl. CPC G06Q 50/16; G06F 16/24545; G06Q 40/02; G06Q 40/06

(57) ABSTRACT

System and methods are disclosed that facilitate the rapid and automated delivery of feedback concerning a potential real estate transaction involving a selected real estate asset. A server is employed to process real estate data and investment criteria to precompute, for each real estate asset of a set of real estate assets, one or more investment assessment measures. Having precomputed the investment assessment measures for the set of real estate assets, investment feedback pertaining to a specific real estate asset may be rapidly transmitted in response to a query from a user of a remote computing device. In some example embodiments, the server is configured to adaptively generate and store one or more investment assessment measures in the event that the query received from the user pertains to a real estate asset that is not a member of the set of real estate assets having associated precomputed investment assessment measures.

### CROSS-REFERENCE TO RELATED APPLICATION

This application claims priority to U.S. Provisional Patent Application No. 62/596,526, titled “SYSTEMS AND METHODS FOR PERFORMING AUTOMATED FEEDBACK ON POTENTIAL REAL ESTATE TRANSACTIONS” and filed on Dec. 8, 2017, the entire contents of which is incorporated herein by reference.

### BACKGROUND

The present disclosure relates to financial analysis and transactions involving real estate assets.

Single family homes, and more generally real estate properties, represent a significant portion of the total asset value in the developed world. The real estate transaction market differs from other markets (such as equity, bonds or currency markets) due, in large part, to the heterogeneity of the characteristics of each individual asset. Each asset has a unique geographic location (e.g. latitude, longitude, distance to metropolitan center) and often has unique property attributes.

Investors or investment entities often make a large volume of investments or purchase offers on real estate assets in the form of mortgages, HELOCs (home equity lines of credit), equity investments or other derivatives tied to the price return performance of the real estate asset. These investors typically encounter large information costs due to resources and time required to evaluate the risk and reward of each individual investment. Because of the heterogeneity of real estate assets, transaction and information costs can be very high.

To gather the information required to execute a transaction in the real estate market, market participants often require an appraisal. A human appraisal is an expensive and time-consuming process, typically requiring a person to visit a property, find locally comparable properties and derive a valuation based on these local comparable properties that have sold recently.

As a result of the high information and transaction costs, and the delays associated with gathering sufficient information to execute a transaction, it can currently take weeks or months to sell an equity stake, acquire financing offers or list and sell a home on the market.

### SUMMARY

Systems and methods are disclosed that facilitate the rapid and automated delivery of feedback concerning a potential real estate transaction involving a selected real estate asset. A server is employed to process real estate data and investment criteria to precompute, for each real estate asset of a set of real estate assets, one or more investment assessment measures. Having precomputed the investment assessment measures for the set of real estate assets, investment feedback pertaining to a specific real estate asset may be rapidly transmitted in response to a query from a user of a remote computing device. In some example embodiments, the server is configured to adaptively generate and store one or more investment assessment measures in the event that the query received from the user pertains to a real estate asset that is not a member of the set of real estate assets having associated precomputed investment assessment measures.

Accordingly, in a first aspect, there is provided a system for providing automated rapid feedback pertaining to potential real estate transactions, the system comprising:

a server comprising memory coupled with one or more processors to store instructions, which when executed by the one or more processors, causes the one or more processors to generate and store automated real estate investment opportunity assessment measures by performing operations comprising:
obtaining real estate asset information associated with a plurality of real estate assets, the real estate asset information comprising location information respectively associated with each real estate asset of the plurality of real estate assets, the real estate asset information further comprising price history data respectively associated with each real estate asset of at least a portion of the plurality of real estate assets;
processing the real estate asset information to determine, for each real estate asset, one or more financial parameters comprising an estimated return; and
for each real estate asset, processing the financial parameters according to investment criteria to generate an investment assessment measure associated with a potential real estate transaction, and storing the investment assessment measure in association with the real estate asset in a database;

the server being further configured to provide automated and low-latency feedback regarding a potential real estate transaction in a selected real estate asset by performing operations comprising:
receiving, from a remote computing device, input identifying the selected real estate asset;
querying the database to determine whether or not the database includes an investment assessment measure associated with the selected real estate asset;
in the event that the database includes an investment assessment measure associated with the selected real estate asset:
   transmitting, to the remote computing device, feedback based on the investment assessment measure, thereby providing rapid feedback of a potential real estate transaction associated with the selected real estate asset; and
in the event that the database omits an investment assessment measure associated with the selected real estate asset:
   processing the real estate asset information to determine, for the selected real estate asset, one or more financial parameters comprising an estimated return;
   processing the one or more financial parameters associated with the selected real estate asset according to the investment criteria to generate an investment assessment measure associated with a potential real estate transaction in the selected real estate asset;
   transmitting, to the remote computing device, feedback based on the investment assessment measure, thereby providing feedback of the potential real estate transaction associated with the selected real estate asset; and
   storing the investment assessment measure in association with the selected real estate asset in the database to enable rapid feedback during subsequent queries associated with the selected real estate asset.

In another aspect, there is provided a method of providing automated rapid feedback pertaining to potential real estate transactions, the method comprising:

obtaining real estate asset information associated with a plurality of real estate assets, the real estate asset information comprising location information respectively associated with each real estate asset of the plurality of real estate assets, the real estate asset information further comprising price history data respectively associated with each real estate asset of at least a portion of the plurality of real estate assets;

processing the real estate asset information to determine, for each real estate asset, one or more financial parameters comprising an estimated return; and

for each real estate asset, processing the financial parameters according to investment criteria to generate an investment assessment measure associated with a potential real estate transaction, and storing the investment assessment measure in association with the real estate asset in a database;

the method further comprising providing automated and low-latency feedback regarding a potential real estate transaction in a selected real estate asset by:
receiving, from a remote computing device, input identifying the selected real estate asset;
querying the database to determine whether or not the database includes an investment assessment measure associated with the selected real estate asset;
in the event that the database includes an investment assessment measure associated with the selected real estate asset:
   transmitting, to the remote computing device, feedback based on the investment assessment measure, thereby providing rapid feedback of a potential real estate transaction associated with the selected real estate asset; and
in the event that the database omits an investment assessment measure associated with the selected real estate asset:
   processing the real estate asset information to determine, for the selected real estate asset, one or more financial parameters comprising an estimated return;
   processing the one or more financial parameters associated with the selected real estate asset according to the investment criteria to generate an investment assessment measure associated with a potential real estate transaction in the selected real estate asset;
   transmitting, to the remote computing device, feedback based on the investment assessment measure, thereby providing feedback of the potential real estate transaction associated with the selected real estate asset; and
   storing the investment assessment measure in association with the selected real estate asset in the database to enable rapid feedback during subsequent queries associated with the selected real estate asset.

In another aspect, there is provided a system for providing automated rapid feedback pertaining to potential real estate transactions, the system comprising:

a server comprising memory coupled with one or more processors to store instructions, which when executed by the one or more processors, causes the one or more processors to generate and store financial parameters associated with real estate assets by performing operations comprising:
obtaining real estate asset information associated with a plurality of real estate assets, the real estate asset information comprising location information respectively associated with each real estate asset of the plurality of real estate assets, the real estate asset information further comprising price history data respectively associated with each real estate asset of at least a portion of the plurality of real estate assets;
processing the real estate asset information to determine, for each real estate asset, one or more financial parameters comprising an estimated return, and storing the one or more financial parameters in a database;

the server being further configured to provide automated and low-latency feedback regarding a potential real estate transaction in a selected real estate asset by performing operations comprising:
receiving, from a remote computing device, input identifying the selected real estate asset;
querying the database to determine whether or not the database includes one or more financial parameters associated with the selected real estate asset;
in the event that the database includes one or more financial parameters associated with the selected real estate asset:
   processing the financial parameters associated with the selected property according to investment criteria to generate an investment assessment measure associated with a potential real estate transaction in the selected real estate asset;
   storing the investment assessment measure in association with the selected real estate asset;
   transmitting, to the remote computing device, feedback based on the investment assessment measure, thereby providing rapid feedback of a potential real estate transaction associated with the selected real estate asset; and
in the event that the database omits an investment assessment measure associated with the selected real estate asset:
   processing the real estate asset information to determine, for the selected real estate asset, one or more financial parameters comprising an estimated return;
   processing the one or more financial parameters associated with the selected real estate asset according to the investment criteria to generate an investment assessment measure associated with a potential real estate transaction in the selected real estate asset;
   transmitting, to the remote computing device, feedback based on the investment assessment measure, thereby providing feedback of the potential real estate transaction associated with the selected real estate asset; and
   storing the investment assessment measure in association with the selected real estate asset in the database to enable rapid feedback during subsequent queries associated with the selected real estate asset.

In another aspect, there is provided a method of providing automated rapid feedback pertaining to potential real estate transactions, the method comprising:

obtaining real estate asset information associated with a plurality of real estate assets, the real estate asset information comprising location information respectively associated with each real estate asset of the plurality of real estate assets, the real estate asset information further comprising price history data respectively associated with each real estate asset of at least a portion of the plurality of real estate assets;

processing the real estate asset information to determine, for each real estate asset, one or more financial parameters comprising an estimated return, and storing the one or more financial parameters in a database;

the method further comprising providing automated and low-latency feedback regarding a potential real estate transaction in a selected real estate asset by:
receiving, from a remote computing device, input identifying the selected real estate asset;
querying the database to determine whether or not the database includes one or more financial parameters associated with the selected real estate asset;
in the event that the database includes one or more financial parameters associated with the selected real estate asset:
   processing the financial parameters associated with the selected property according to investment criteria to generate an investment assessment measure associated with a potential real estate transaction in the selected real estate asset;
   storing the investment assessment measure in association with the selected real estate asset;
   transmitting, to the remote computing device, feedback based on the investment assessment measure, thereby providing rapid feedback of a potential real estate transaction associated with the selected real estate asset; and
in the event that the database omits an investment assessment measure associated with the selected real estate asset:
   processing the real estate asset information to determine, for the selected real estate asset, one or more financial parameters comprising an estimated return;
   processing the one or more financial parameters associated with the selected real estate asset according to the investment criteria to generate an investment assessment measure associated with a potential real estate transaction in the selected real estate asset;
   transmitting, to the remote computing device, feedback based on the investment assessment measure, thereby providing feedback of the potential real estate transaction associated with the selected real estate asset; and
   storing the investment assessment measure in association with the selected real estate asset in the database to enable rapid feedback during subsequent queries associated with the selected real estate asset.

In another aspect, there is provided a system for providing automated rapid financial information pertaining to real estate assets, the system comprising:

a server comprising memory coupled with one or more processors to store instructions, which when executed by the one or more processors, causes the one or more processors to generate and store financial parameters associated with real estate assets by performing operations comprising:
obtaining real estate asset information associated with a plurality of real estate assets, the real estate asset information comprising location information respectively associated with each real estate asset of the plurality of real estate assets, the real estate asset information further comprising price history data respectively associated with each real estate asset of at least a portion of the plurality of real estate assets;
processing the real estate asset information to determine, for each real estate asset, one or more financial parameters comprising an estimated return and storing the one or more financial parameters in a database;

the server being further configured to provide, to a remote computing device, financial parameters associated with a selected real estate asset by performing operations comprising:
receiving, from the remote computing device, input identifying the selected real estate asset;
querying the database to determine whether or not the database includes one or more financial parameters associated with the selected real estate asset;
in the event that the database includes one or more financial parameters associated with the selected real estate asset, transmitting the one or more financial parameters to the remote computing device; and
in the event that the database omits an investment assessment measure associated with the selected real estate asset:
   processing the real estate asset information to determine, for the selected real estate asset, one or more financial parameters comprising an estimated return; and
      storing the one or more financial parameters in association with the selected real estate asset in the database to enable rapid feedback during subsequent queries associated with the selected real estate asset.

In another aspect, there is provided a method for providing automated rapid financial information pertaining to real estate assets, the method comprising:
obtaining real estate asset information associated with a plurality of real estate assets, the real estate asset information comprising location information respectively associated with each real estate asset of the plurality of real estate assets, the real estate asset information further comprising price history data respectively associated with each real estate asset of at least a portion of the plurality of real estate assets;
processing the real estate asset information to determine, for each real estate asset, one or more financial parameters comprising an estimated return and storing the one or more financial parameters in a database;
the method further comprising providing financial parameters associated with a selected real estate asset by:
   receiving, from a remote computing device, input identifying the selected real estate asset;
   querying the database to determine whether or not the database includes one or more financial parameters associated with the selected real estate asset;
   in the event that the database includes one or more financial parameters associated with the selected real estate asset, transmitting the one or more financial parameters to the remote computing device; and
   in the event that the database omits an investment assessment measure associated with the selected real estate asset:
      processing the real estate asset information to determine, for the selected real estate asset, one or more financial parameters comprising an estimated return; and
         storing the one or more financial parameters in association with the selected real estate asset in the database to enable rapid feedback during subsequent queries associated with the selected real estate asset.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 shows an example system for providing rapid feedback in response to a user query pertaining to a potential real estate transaction involving a selected real estate asset, wherein the feedback is provided based on precomputed investment assessment measures for a plurality of real estate assets.

FIG. 2A is a flow chart illustrating an example method of precomputing financial parameters and investment assessment measures.

FIG. 2B is a flow chart illustrating an example method in which precomputed investment assessment measures are employed to provide rapid feedback in response to a user query involving a potential real estate transaction involving a selected real estate asset.

FIG. 2C is a flow chart illustrating an example method of dynamically and adaptively generating and transmitting a response to a user query pertaining to a potential real estate transaction involving a selected real estate asset, where precomputed investment assessment measures are not available.

FIG. 3 is a table illustrating example investment assessment measures that are generated for different properties, according to three different types of investment criteria.

FIG. 4A is a diagram of an example remote computing device.

FIG. 4B is a diagram of an example server.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

As described above, real estate transactions are typically plagued by high information and transaction costs, and long delays in gathering sufficient information to execute a transaction. Moreover, such costs and delays often serve as a barrier to the adoption and proliferation of new real estate investment vehicles, such as real estate equity investments, especially through online sales channels.

These costs and delays present a significant impediment to the automation of the pre-approval of potential real estate transactions. The modern online consumer has a very low tolerance for delays, and has been conditioned to expect rapid feedback in response to online queries. For example, online shopping portals provide consumers with the ability to rapidly obtain information concerning new products (based on product information and customer reviews), thereby facilitating a rapid decision making and a quick and efficient online purchase. Likewise, the modern investor now has access to online investment portals that provide real-time information concerning potential investments, as well as the ability to quickly and efficiently execute trades at low cost.

By comparison, the modern real estate investor appears to have been left behind from a technology perspective, and is woefully lacking the computational tools needed to make clear decisions with high efficiency and low latency. Although some online portals now offer online home valuation estimates, the information required for an investor to make a clear decision regarding a potential real estate investment requires financial information that goes significantly beyond a mere present-day valuation, as real estate investment decisions require the meaningful analysis of future return and risk. Indeed, since real estate investments are typically long-term investments, the assessment of the relative opportunity that a given real estate asset presents to an investor typically requires the use of complex models that forecast the expected return (and optionally the associated risk) of the real estate asset.

It is therefore clear that present-day online tools that quantify real estate investment opportunities and enable actionable decision making continue to elude the modern day real estate investor. Indeed, the need to obtain a clear and quantitative estimate of the potential return on investment would presently force the real estate investor to spend an inordinate amount of time compiling the requisite information to support such a calculation, as well as significant time and effort to build an appropriate financial model to quantify the potential return on a real estate transaction. It therefore follows that the real estate investor presently faces a technical problem that is manifested in the absence of suitable tools that support the rapid and efficient assessment of potential real estate opportunities.

The present inventors, having identified this technical problem, set out to develop technical solutions that facilitate the rapid and online delivery of feedback associated with potential real estate transactions. In some example embodiments of the present disclosure, a system is disclosed that facilitates the rapid and automated delivery of feedback concerning a potential real estate transaction involving a selected real estate asset. This is achieved by employing a server to process real estate data and investment criteria to precompute, for each real estate asset of a set of real estate assets, one or more investment assessment measures. Having precomputed the investment assessment measures for the set of real estate assets, investment feedback pertaining to a specific real estate asset may be rapidly transmitted in response to a query from a user of a remote computing device.

As described above, by precomputing the investment assessment measures, the server is capable of efficiently and rapidly delivering feedback to a user of a remote computing device. In some example embodiments, the feedback is provided with a processing delay (not including network transmission and latency delay) that is perceived by the user as being “real-time”, which is hereby defined as a processing delay of less than one second. In other example embodiments, the processing delay may be less than 15 seconds, less than 10 seconds, 5 seconds, less than 2 seconds, less than 0.5 seconds, less than 0.2 seconds, or less than 0.1 seconds. Providing such rapid feedback in response to a user query, based on the rapid acquisition of the relevant precomputed investment assessment measure associated with the selected real estate asset, provides a technical solution to the aforementioned technical problem otherwise faced by the modern real estate investor.

Providing such automated and rapid feedback can be of paramount value, for example, to a customer looking to purchase a home, or a customer who currently owns a home and would like to either sell or use the home as collateral in a financial contract. Furthermore, given the low attention span and low tolerance for latency of the modern online consumer, the ability to deliver rapid feedback pertaining to a potential real estate transaction can be critical in ensuring that would-be customers remain engaged and “click through” the feedback that is generated.

The present solution of precomputing the investment assessment measures can be appreciated as providing a technical solution when one considers the alternative approach in which an investment assessment measure is not precomputed, but is instead generated, based on the processing of real estate information associated with a broad set of real estate assets, and the generation of a complex financial model, only after having received a query from a user of a remote computing device. In such a case, it may be possible to generate and deliver feedback to the user of the remote computing device within a reasonable time delay—for example, a few seconds—provided that only a single query is received at a time. However, in the event that multiple queries are concurrently received by the server, the system can rapidly become overwhelmed, and the computational requirements for the processing—in parallel—of the investment assessment measures for the multiple real estate assets selected by the multiple queries, could result in significant additional latency due to the processor bottlenecks. In such cases, additional delays may be encountered by the users, and these delays may cause some or all of the users to abandon their query, resulting in lost opportunities and associated revenue. Moreover, in the event that the delay in providing feedback to a user is dependent on the volume of user queries, such system behavior may result in a poor user experience, with the consequence that some users may forgo use of the system. Furthermore, the need to perform parallel computation of investment assessment measures would render the system particularly susceptible to attacks by hackers, further undermining the stability and reputation of the system.

In some example embodiments, the system is configured to adaptively generate and store one or more investment assessment measures in the event that the query received from the user pertains to a real estate asset that is not a member of the set of real estate assets having associated precomputed investment assessment measures. In such cases, due to the absence of a respective investment assessment measure associated with the selected real estate asset, the server is not initially able to immediately provide feedback pertaining to a potential real estate transaction. However, the server may nonetheless compute one or more investment assessment measures for the selected real estate asset dynamically (“on the fly”) by obtaining additional real estate information pertaining to an additional set of real estate assets that satisfy similarity criteria associated with the selected real estate asset, and processing the additional real estate information in association with investment criteria. The resulting one or more investment assessment measures may then be stored, such that they are subsequently available, in a precomputed state, for future queries pertaining to the selected real estate. According to such an example embodiment, the system adaptively adds additionally precomputed investment assessment measures based on user queries in order to support the rapid delivery of feedback for future queries.

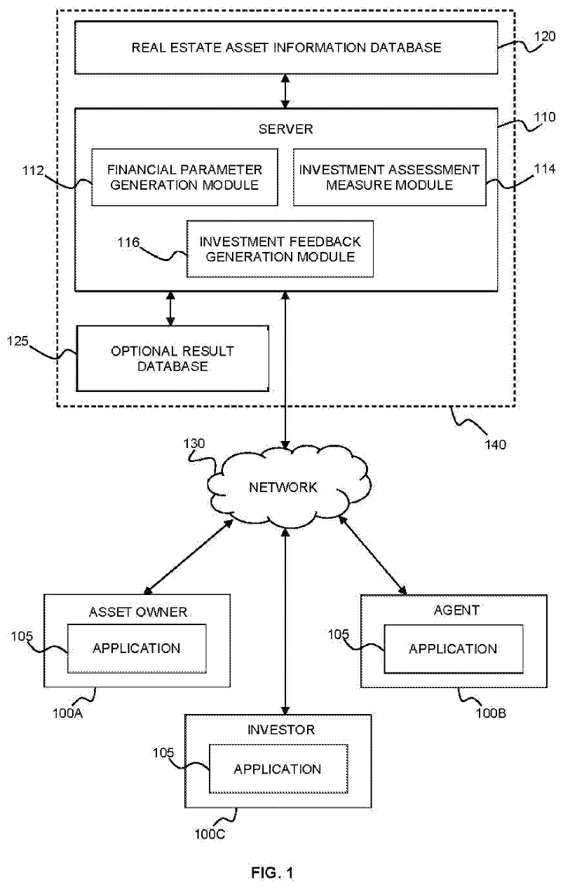

Referring now to FIG. 1, an example system for processing real estate information and providing rapid feedback pertaining to a potential real estate transaction involving a selected real estate asset is shown. The example system includes a server 110, which is interfaced with (operably connected to) a real estate information database 120 that includes real estate asset information associated with a plurality of real estate assets. The server 110 receives queries through the network 130 from one or more remote computing devices 100A-C, and generates and transits feedback regarding potential real estate transactions, based on precomputed investment assessment measures that are generated by processing the real estate information database 120 and predetermined investment criteria.

As described in further detail below, the server 110 includes a processor and a memory, where the processor is configured to execute instructions stored in the memory in order to precompute financial parameters associated with a plurality of real estate assets based on the processing of real estate asset information stored in the real estate asset information database 120 (and optionally one or more additional sources databases), as represented by financial parameter generation module 112. The financial parameters quantify financial metrics that are associated with a potential investment in a given real estate asset, such as, but not limited to, measures of risk and/or return. Financial measures may be processed according to investment criteria in order to generate one or more investment assessment measures that provide measures of the attractiveness or opportunity associated with an investment or derivative, as described in further detail below. The server also includes an investment assessment module 114 that further processes the financial parameters in order to precompute one or more investment assessment measures, as further described below. The precomputed financial parameters, and the associated investment assessment measures, may be stored, for example, in the real estate information database 120, one or more additional databases (such as optional result database 125), or a combination thereof. The server is further configured to receive a query from a remote computing device 100N, the query identifying a selected real estate asset associated with a potential real estate transaction, and to rapidly generate, based on the precomputed investment assessment measure associated with the selected real estate asset, feedback associated with the potential real estate transaction, and to transmit the feedback to the respective remote computing device 100N, as represented by investment feedback generation module 116.

The example system in FIG. 1 may be employed to provide rapid feedback associated with a potential real estate transaction for a wide variety of types of real estate transactions. However, the forthcoming example provides a heuristic and non-limiting example embodiment in which the server 110 is configured to generate and deliver feedback associated with a potential real estate transaction involving a type of financial derivative (e.g. financial contract), known as “real estate equity investment” or a “home ownership investment”. It will be understood that the example embodiment described below may be adapted according to many different types of financial transactions, and non-limiting examples thereof are described below.

Real estate equity investments, also known as “home ownership investments”, are a relatively new category of real estate investment vehicles, and involve an investor providing funds to an owner of a real estate asset in exchange for an agreed upon share of the proceeds of a future sale of the real estate asset, such that the investment is made with a contingent claim on the underlying real estate asset. Accordingly, a real estate equity investment may be an agreement between an investor and the homeowner relating to the investor's contingent claim on the future value of the home. An example of an investment is a call option, put option, home ownership investment, mortgage, reverse mortgage, home equity line of credit, or fractional equity purchase in the real estate asset.

For example, a real estate equity investment transaction between an investor and a homeowner may be structured at the onset of a home purchase, such that the investor provides a portion of the down payment on the condition that when the home is subsequently sold, the investor receives a cash flow based on the change in value of the home. In another example scenario, a real estate equity investment transaction between an investor and a homeowner may be structured after the purchase of a home, such that the investor provides cash to the homeowner in return for a predetermined percentage of the change in the value of the home when the home is sold in the future. In some example implementations, a real estate equity investment contract may include an option for the owner of the asset to purchase (buy out) the investment, optionally during a prescribed time window relative to the initiation of the contract. Rather than using the sale price to determine the value of the investment, a third-party appraisal can be used to estimate the fair value of the asset.

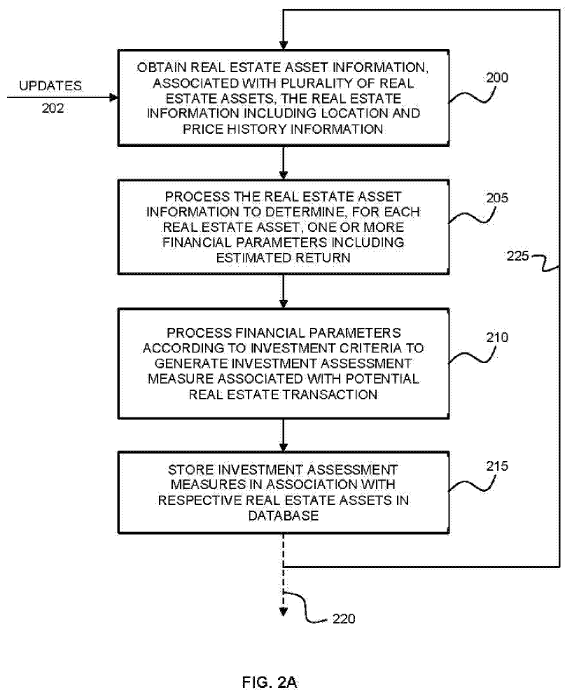

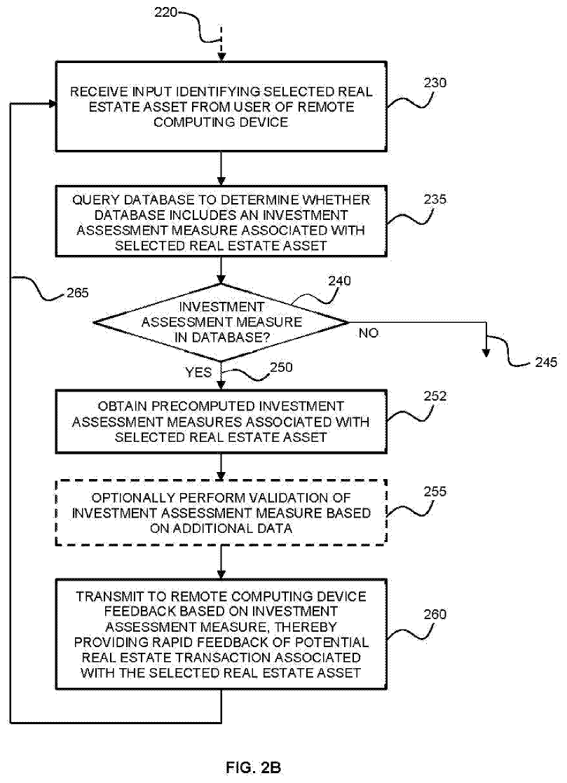

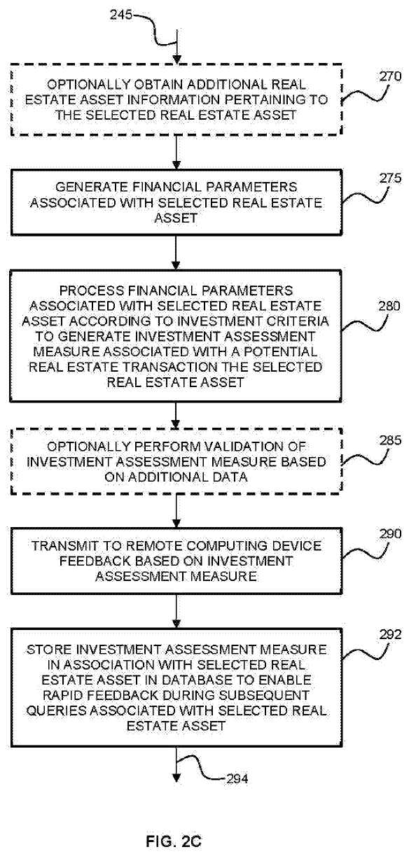

FIGS. 2A to 2C provide flow charts that illustrate an example method of generating feedback associated with the pre-qualification status of a potential real estate equity investment involving a selected real estate asset. This example method, and/or variations thereof, may be executed by server 100 of FIG. 1. FIG. 2A illustrates the processing steps involved in the precomputation of investment assessment measures respectively associated with a plurality of real estate assets, while FIG. 2B illustrates the processing steps involved in the rapid delivery of feedback associated with the pre-qualification of a potential real estate equity investment in response to a user query involving a selected real estate asset, where the feedback is based on a precomputed investment assessment measure associated with the selected real estate asset. FIG. 2C illustrates the processing steps involved in the adaptive computation of an investment assessment measure associated with a selected real estate asset for which a precomputed investment assessment measure is not available, and the storing of the investment assessment measure to facilitate rapid delivery of feedback in the event of a future inquiry involving the selected real estate asset.

Referring first to FIG. 2A, in steps 200-210, real estate asset information associated with a plurality of real estate assets is obtained for preprocessing in order to determine, for each real estate asset, an investment assessment measure associated with a potential real estate transaction. These investment assessment measures, having been precomputed by the server, may subsequently be employed according to the method of FIG. 2B to provide rapid feedback regarding a potential real estate transaction involving a selected real estate asset, in response to a query submitted from the user identifying the selected real estate asset.

In some example embodiments, the determination of a suitable investment assessment measure for each real estate asset, according to predetermined investment criteria, involves initial calculations that generate financial parameters, such as an estimated return, and these financial parameters that are subsequently processed, according to investment criteria, in order to arrive at one or more investment assessment measures that quantify the investment opportunity and facilitate decision making. As used herein, the term “investment assessment measure” refers to a measure of the attractiveness or opportunity associated with an investment or derivative. In the context of many of the example embodiments described herein, a derivative is a contingent claim on real estate property. The measure of relative attractiveness or opportunity can be a function of reward and risk. For example, an investment assessment measure can be determined based on financial parameters such as reward measures, which may include, but are not limited to, expected return of the investment, expected IRR of a portfolio of the investments, and/or net present value of the investment, where the financial parameters are assessed according to investment criteria. An investment assessment measure may also be based on risk measures such as, but not limited to, the expected standard deviation or downside standard deviation of the investment, the expected standard deviation or downside standard deviation of the IRR of a portfolio of the investments, and/or the standard error of the net present value of the investment or value-at-risk (VaR) of the portfolio of investments. For certain investors, the expected timing of cash flows may be included in the generation of an investment assessment measure. For a pension fund, endowment fund, sovereign wealth fund or other funds who are actively matching assets with liabilities or expected cash outflows with expected cash inflows, a minimum required cash flow return in each time period can be applied as investment criteria that places a constraint on whether or not an investment is made.

Referring again to FIG. 2A, prior to computing the financial parameters for each real estate asset, real estate asset information is collected in step 200, where the real estate information includes information suitable for identifying each asset of the set of real estate assets, such as a location of each asset. Location information for any given real estate asset may include, for example, longitude and latitude coordinates, an address, and/or other geolocation information such as, not limited to, country, state, county FIPS code, zip code (5 digit and/or 9 digit), census tract code, and census block code. The real estate information further includes, for at least a portion of the plurality of real estate assets, price history data associated with prior sales. The price history data for a given real estate asset may include one or more prior sale prices for the given real estate asset.

As described below, in some example embodiments, the calculations of financial parameters may be based on real estate asset information that extends beyond location and prior pricing data. Accordingly, the real estate asset information database 120 may include additional information for one or more real estate assets. For example, in some example implementations, the real estate asset information database 120 can further include data such as, but not limited to additional geolocation data (e.g. distance to metropolitan center), hedonic data (e.g. square footage of lot, square footage of building, number of bedrooms, number of bathrooms), additional financial data (e.g. current mortgage information pertaining to the real estate asset) and data associated with the current homeowner or owner on title (i.e. credit score, current assets, income and liabilities).

For example, in some example implementations, the real estate asset information database 120 may include, for one or more assets, mortgage and other lien information, such as data concerning current or previous mortgages, or other financial liens, including interest rates, interest rate type (fixed or floating), duration (term), amortization schedule, loan-to-value at origination, combined-loan-to-value at origination, prepayment penalties, private mortgage insurance payments, seniority (or lien priority if multiple liens). In some example implementations, the real estate asset information database may include, for one or more real estate assets, hedonic data such as an estimated home characteristic data including the number of bedrooms, number of bathrooms, and square footage of land/building. In some example implementations, the real estate asset information database may include, for one or more real estate assets, economic data by geolocation, such as income and income growth data, number of jobs, and diversity of industries (Herfindahl-Hirschman index). In some example implementations, the real estate asset information database may include, for one or more real estate assets, homeowner data, such as FICO score, debt to income ratio, liquid savings, total assets.

In some example implementations, in the absence specific real estate information for a given real estate asset (other than identifying location data), geo-specific averages can be used to provide additional dimensionality (i.e. additional fields). For example, in the absence of the availability of hedonic data for a given real estate asset, an average expected return can be estimated for a “typical” property proximal to that geographic location. In the absence of geographic data, regional or national averages may alternatively be employed.

While national averages of any of the financial parameters can be employed, conditioning these parameters on at least one of geographic, hedonic or homeowner variables is necessary to distinguish between properties or between groups of similar properties. For example, Case-Shiller repeat sales indices can be fit to each zip code in America and properties can be distinguished at a zip code level granularity. Alternatively, property parameters can be conditioned by property type (condo, single family home, etc.) or number of bedrooms/bathrooms. Finally, the parameters can be conditioned on the proximity of the property to geo-economic variables such as job centers or proximity to other properties.

It will be understood that the real estate information employed for the generation of the financial parameters may be obtained from a wide variety of sources, and that the system configuration shown in FIG. 1 provides but one example of a suitable architecture. In one example implementation, the real estate asset information database 120 may reside at a common location, or within a common computing device, with the server 110, as illustrated by dashed line 140. In other example implementations, the real estate asset information may be stored in two or more databases, where one or more of the databases may be external databases (e.g. managed or owned by a third party).

Furthermore, in some example embodiments, the real estate information may be cleaned and/or validated prior to being employed for the calculation of financial parameters according to the methods described below. In some example implementations in which multiple data sources are employed to construct the real estate information the multiple data sources may be combined and validated prior to use. For example, certain economic, demographic, environmental, or location information could be matched to individual properties according to geographic identifiers, including, but not limited to, country, state, county, and zip code. In addition, in cases in which property attribute data is missing, such as the number of bedrooms or bathrooms, values may be estimated based on some aggregate measure, such as the median or average, of nearby properties with available data. In some instances, fields may be type-transformed (e.g., text to Boolean) or combined to form derivative fields, such as loan-to-value or land-to-cost ratios.

Referring again to FIG. 2A, the real estate information is processed, as shown at step 205, to determine, one or more financial parameters for each real estate asset of the plurality of real estate assets. As described in further detail below, the one or more financial parameters associated with a given real estate asset are selected such that they may be further processed, with investment criteria, in order to obtain an investment assessment measure quantifying the potential investment opportunity associated with the given real estate transaction. In some example implementations, the one or more financial parameters associated with a given real estate asset may include at least an expected return associated with a potential real estate transaction involving the given real estate asset. Various non-limiting examples of suitable financial parameters are described below.

For example, the following five financial parameters may be calculated: (1) current real estate asset value, (2) long-run expected return, (3) volatility of returns, (4) correlation to total real estate market index, and (5) turnover rate. It will be understood that these five financial parameters are not intended to be limiting, and that the financial parameters generated in order to facilitate the computation of an investment assessment measure may include greater or fewer financial parameters than those present in the preceding list. For example, in some example embodiments, the financial parameters that are generated may include an expected return, and optionally one or more additional financial parameters, where the additional financial parameters may optionally include one or more financial parameters from the preceding list. The following paragraphs provide non-limiting examples of methods of computing the five example financial parameters listed above.

In one non-limiting example implementation, the first financial parameter, the current real estate valuation (current price), may be calculated using any one or more of variety of supervised machine learning algorithms. A common approach is to use a K-nearest neighbor algorithm. Specifically, the algorithm tries to identify the closest set of K houses to a given house based on a set of characteristics. The simplest characteristics to consider are latitude and longitude. In this case, the algorithm identifies the K closest houses in Euclidean space.

However, valuation calculations can be generalized to include other dimensions, such as, but not limited to, time since last sale, and hedonic variables such as number of bedrooms, number of bathrooms, and square footage. For example, each dimension can have a unique associated weight. Suitable weights can be estimated, for example, using “leave-one-out” prediction methods for a sample set of homes. For example, a subset of homes can be removed from the sample set, and the weights can be optimized to minimize the squared error between the predicted sale price and the actual sale price of the subset.

Many other models may additionally or alternatively be employed to estimate the current real estate valuation. Some examples of suitable supervised models include, but are not limited to, linear regression, SVM, random forests and neural networks. In some example implementations, the output of each model of a set of models can be combined in an ensemble. Such an implementation may be employed for boosting, in which a set of weak models are combined to produce a strong model.

In one example implementation, the second example parameter, long-run expected return, may be estimated by fitting a repeat sales model to pairs of sales of a specific home. An example of a sale pair would be a home that is purchased in year 2000 and sold in year 2015. A repeat sales model aims to estimate the average return of homes in each time period. The parameters of this model, i.e. the return for each period, may be optimized to minimize the square prediction error of each sale pair. The model can be further improved by weighing each sale pair by the inverse of the square root of expected variance of returns over the holding period. This is a common whitening transformation in statistics. Suppose that the known variance of returns is a linear function comprising a constant and a term proportional to time, each return can be reweighted by the reciprocal of the square root of their respective expected variance. This is an example of a weighted repeat sales model similar to the Case-Shiller repeat sales index.

Repeat sales models can be produced for large collections of homes (e.g. over the United States) to determine a benchmark average historical real estate return index. The average return of this index may be employed as an initial estimate of future long-run real estate returns.

In some example implementations, a repeat sales model may be employed to generate estimated returns for each unique location in a series of geographic granularities such as state, county, zip code, and city.

In other example implementations, a repeat sales model may be employed to generate estimate returns by economic grouping data, where the estimated returns are calculated according to proximity to job centers and/or supply density of other real estate properties.

The repeat sales model may be further refined based on additional dimensions, such as, but not limited to, hedonic property data such as number of bedrooms, number of bathrooms, and square footage. In one example embodiment, a repeat sales model may be employed to generate estimated returns based on one or more of geographic granularity, economic grouping and hedonic variables, and the estimated returns computed according to such a refined repeat sales model will exhibit small tilts in long-run historical returns.

The dependence of the model on these additional attributes (and the associated tilts) may be employed to forecast future returns of a selected real estate asset, provided that information associated with the selected real estate asset (e.g. its geographic granularity, economic grouping, and/or hedonic properties) is available. Regularization techniques such as Tikhonov (Ridge) and Lasso regression techniques may be applied to avoid over-fitting data, especially for variables combinations with very few sale pairs.

In addition to repeat sales models, return series can be estimated with autoregressive or asset pricing theory models which can leverage data on homes with only a single sale.

The third example parameter, namely a measure of volatility, can be computed, for example, by calculating the volatility of annual returns of the individual sales pair data to determine the expected future volatility. This may be performed by fitting the observed variance (square of volatility) of returns-over-time to a chi-squared distribution. For example, the variance may be fitted to an affine function in time (i.e. a function that includes both a constant and a term that is linear in time).

In order to decompose variance into correlated variance and uncorrelated variance and obtain a measure of correlation as per the fourth example financial parameter, the computation of variance can be repeated with the remaining sample variance of sale pairs after subtracting the return predictions from the repeat sales model (i.e. the residual variance from the repeat sale model), thereby obtaining a second variance estimation. The difference between the first and second variance estimations represents the correlated components of variance. The second variance estimation represents the idiosyncratic variance (i.e. the variance that cannot be explained by the index). The variance analysis can be repeated for geographic granularities, hedonic variables and economic groupings.

The fifth and final example financial parameter in the example list provided above is the turnover rate. This can be estimated, for example, by optimizing the parameters of a hazard rate/survival model to maximize a likelihood function of a data vector comprising the holding periods of sale pairs among a set of real estate assets. In addition, properties that have only sold once (i.e. a data point that is not yet a sale pair) may be incorporated into the calculation by employing right-censoring techniques in hazard rate modelling. It will be understood that a variety of models may be employed as a baseline model, such as the exponential distribution, the log-logistic distribution, the Weibull distribution or the PSA curve. Exponential covariates may be included to differential turnover models by geographic granularity, hedonic variables and economic groupings.

Certain model selections may be deemed priors. For example, the choice of using a repeat sales index instead of a weighted repeat sales index, or the choice of using an exponential distribution instead of a Weibull distribution can be selected before optimizing the aforementioned models. Parameters may also be set before fitting the aforementioned models. For example, a home may be arbitrarily categorized as being urban if it has more than 100 homes within a one mile radius, whereas other homes are classified as rural. The choice of 100 homes or the choice of a one mile radius are hyper-parameters. Both prior model selections and hyper-parameters can be further optimized by using out-of-sample testing. Specifically, the expected return model can be fit to a random sample of 90% of training data using different values for a particular hyperparameter, and the model that best fits the remaining 10% of the training data can be chosen.

According to the present example method, having calculated the five example financial parameters for the selected real estate asset (in the present example, asset valuation, return, volatility, correlation and turnover rates), the financial parameters may be further processed, in order to generate one or more additional financial parameters, prior to generating one or more investment assessment measures based on investment criteria to quantify the relative attractiveness of a potential transaction involving the selected real estate asset. For example, in one example implementation, the preceding financial parameters may be processed according to methods such as Monte Carlo simulation, Grid/Tree based methods and Closed Form valuation methods in order to generate one or more additional financial parameters. Such methods can be implemented, for example, to estimate the risk neutral price, the risk-weighted price, the estimated internal rate of return (IRR) and return and risk (volatility or down-side volatility) expectation of an investment on the real estate asset. For example, the Monte Carlo method can use estimates of expected return and volatility to simulate 10,000 home price paths. A value of the investment can then be computed along each of the home price paths. The turnover model provides the probability that an investment will pay out in a given time period. With an initial investment amount as a cash outflow, and a series of expected future cash inflows, an IRR can be computed by estimating the discount rate which would make the net present value of the investment zero. Alternatively, with a provided investor discount rate, the net present value of the investment can be determined. In both cases, an average of the 10,000 simulations can be used to estimate for the IRR and the NPV. Standard deviations across the simulations can be interpreted as a measure of risk.

Referring again to FIG. 2A, having precomputed the financial parameters for the set of real estate assets, the financial parameters are subsequently processed, according to investment criteria, to determine one or more respective investment assessment measures for each real estate asset, as shown in step 210. According to the present example embodiment involving the generation of five financial parameters per real estate asset, examples of suitable investment assessment measures include, but are not limited to, a binary pre-qualification decision, a pre-qualification score. The investment assessment measures may further comprise, for example, terms associated with an offer of investment, such as potential investment amounts, equity share, interest rates, and term, and/or constraints associated with an offer of investment, including expiration date of offer or conditions pertaining to the real estate asset, such as required occupancy status. In some example embodiments, the financial parameters may be processed to determine a binary investment decision, as well as terms and/or constraints, and a positive decision may be represented by the presence of such terms and/or constraints.

An additional financial parameter (which can be estimated to supplement the previously mentioned five financial parameters) is the expected rental yield on a real estate property. In an example embodiment, the rental yield is estimated based on the average or median rental yield or rental monthly rate of similar rental properties that have live rental postings or have recently executed a rental contract with a tenant. When estimating expected rental yield, a real estate is deemed similar based on a geographic component. Specifically, properties in the same geographic region such as state, county or zip code are deemed similar with respect to geographic region. Properties can also be geographically similar based on actual distance (e.g. Euclidean distance) if the latitude and longitude of real estate properties are known. Since homes with more bedrooms and bathrooms tend to command a higher rental rate, the sample of similar homes may only include homes with the same number of bedrooms, or having within plus or minus one bedroom of the property whose rental yield we are estimating. As time goes by, rental yields or rental rates may change. Therefore, the sample may only include properties whose rental postings or executed rent contracts are no older than a certain predetermined period of time (e.g. one year).

In one example implementation, one or more investment assessment measures may provide or relate to pre-approval terms, where the terms may include, for example, constraints on amount of the pre-approved investment (e.g. in dollar value or as a percentage of the value of the real estate asset), such as a maximum permissible investment, and/or constraints of the share of the proceeds of a future sale of the real estate asset. In one example embodiment, the terms may prescribe a relationship between investment and future share of proceeds of a sale.

One or more investment assessment measures associated with the potential pre-approval of a real estate equity investment may be determined, for a given real estate asset, by processing both the precomputed financial parameters associated with investment criteria, as follows. For example, in the preceding example implementation in which the initial five financial parameters are further processed to generate additional financial parameter such as risk neutral price, a risk-weighted price, an estimated IRR, return or risk expectation for each real estate asset, the additional financial parameters may be processed, in view of investment criteria providing investment constraints such as minimum expected IRR or return and/or a maximum risk (or some ratio thereof between risk and reward), in order to provide one or more investment assessment measures. For example, the investment criteria (e.g. one or more constraints, thresholds, or other criteria) for a particular type of investment may be employed to divide the set of real estate assets into at least two sets, such as an un-investible set and an investible set. In another example embodiment, a soft-investor constraint region may be employed to create a margin set between the investible set and the un-investible set where properties are flagged for human decisions.

For example, an investor may only invest in at-the-money call options on homes that yield more than 5% expected annual IRR. Monte Carlo simulation of at-the-money call options can be used to generate expected annual IRRs for each at-the-money call options on homes in the database. Homes with at-the-money call options exceeding an expected IRR of 5% per year will be classified as investible and the remainder would not. In another embodiment, an investor may only invest in call options whose ratio of expected IRR to standard deviation of IRR exceeds 0.5. In another embodiment, an investor may consider investing in a range of call options with different strike prices and different initial prices. In these cases, an expected IRR can be generated for each type of call option and only those call options whose IRRs exceed 7% will be investible. All of the investible call options may be submitted to the end user or, alternatively, only the best offer or offers will be submitted to the end user.

In another embodiment, an investment or derivative such as a call option, put option, equity interest and mortgage can be simulated with a Monte Carlo simulation. For each of these investments, expected cash flows can be generated over time with respective standard deviations, standard errors and confidence bands around each time period. An IRR can be calculated, as described above, given an initial price of the investment. An expected return of the investment can be modelled by computing the NPV of the investments over time (as a function of the simulated evolution based on the parameters provided). An NPV can be computed provided a discount rate of the investor. In each of these cases a standard deviation, downside standard deviation can be computed. Alternatively, a VaR can be computed on the NPV of the portfolio by determining the difference between the mean or median NPV (of the Monte Carlo simulations) and the 5^{th}, 10^{th} or some other percentile of the NPVs simulated. An investor may choose to invest in investments that outperform (e.g. exceed investment criteria associated with) one or more of: the IRR, the expected return, or the NPV based on the simulations. An investor may also choose not to invest in investments that have a risk exceeding a certain threshold on the basis of standard deviation or downside standard deviation of IRR, expected return of NPV, or on the basis of a VaR exceeding a certain threshold. A function combining one or more of the reward measures and risk measures described can be used as an investment assessment measure.

In another embodiment, an investor may assess an investment based on the timing and magnitude of cash flows. For a given Monte Carlo simulation, a vector of expected cashflows and standard deviation of those cash flows can be generated for each time period. An investor may require a minimum amount of cash inflow to occur at one or more time periods. Alternatively, an investor may minimize the probability (proportion of simulation paths) that one or more cash inflows from the investment falls short of a minimum magnitude.

As noted above, the one or more investment assessment measures associated with the potential pre-approval of a real estate equity investment may be determined, for a given real estate asset, by processing the precomputed financial parameters and investment criteria. The investment criteria may take on many forms according to different implementations of the present example embodiment. For example, in one example embodiment, the investment criteria may specify a minimum acceptable return on a real estate asset. In another example embodiment, the investment criteria may specify a target internal rate of return for use in computing a present value of a future return. In another example implementation, the investment criteria may establish a relationship between one or more financial parameters and pre-approval terms.

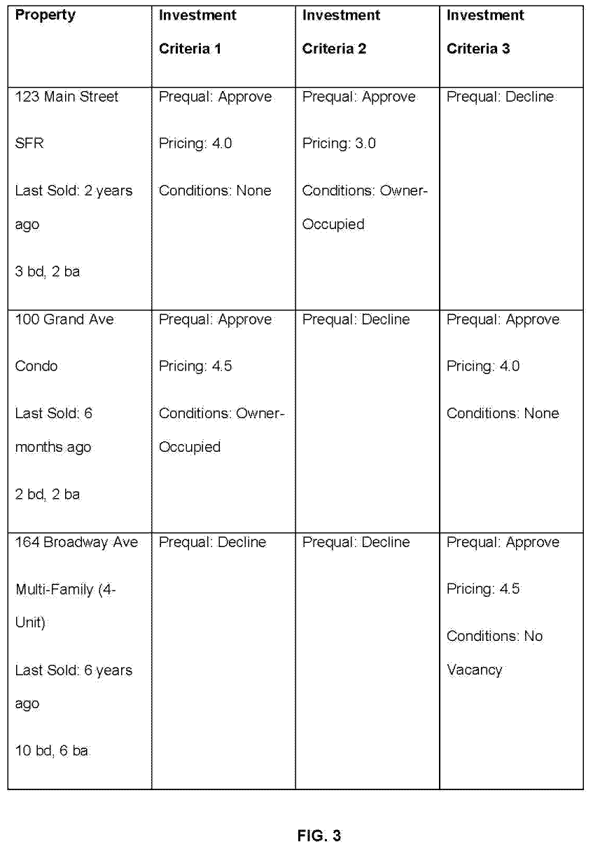

There may exist more than one set of investment criteria that are each evaluated for a potential pre-approval of a real estate equity investment. Each set of investment criteria need not produce the same investment assessment measures for the same property. For example, in one example implementation, there may exist three sets of investment criteria, which could correspond, for example, to different investors or separate condition sets for a single investor, or a combination thereof. Example investment assessment measures for three example properties for each set of criteria are shown in FIG. 3.

The presence of additional investor criteria sets augments the opportunity set of investment assessment measures. For example, the “123 Main Street” property in FIG. 3 would simply have a pre-qualification “Approve” or “Decline” if only Criteria 1 or 3 existed, respectively. The inclusion of Criteria 2 presents another “Approve” offer.

Having calculated the investment assessment measures for the real estate assets in step 210, the investment assessment measures are subsequently stored in step 215. The investment assessment measures associated with a selected real estate asset may then be efficiently and rapidly retrieved in response to a user query, according to the method steps shown in FIG. 2B, in which feedback associated with the pre-approval of a potential real estate equity investment involving a selected real estate asset is rapidly delivered based on the precomputed investment assessment measures.

Referring again to FIG. 2A, the calculation of the financial parameters and the resulting investment measures may be repeated one or more times, as shown at 225. For example, such a recalculation may be automatically triggered, optionally on a per-asset basis, when updated real estate asset information is obtained, as shown at 202, or, for example, according to a prescribed schedule.

As noted above, the recalculation of the financial parameters and investment assessment measures need only be performed intermittently (e.g. periodically), and the output of the computations can therefore remain relevant for a period substantially longer than the time it takes to compute the financial outputs. The computations can be rerun when new real estate asset information is uploaded or when a predetermined amount of time has passed. The financial parameters and investment assessment measures can be stored for an extended period allowing resources to be allocated to maximizing lookup speed and responsiveness rather than updating the results in the database.

In some example embodiments, the financial parameters may be computed on a per-asset basis, for example, according to any of the methods described above. The per-asset financial parameters may then be processed, on a per-asset level, to generate one or more investment assessment measures, as described above. It is further noted that step 210 may be repeated, on a global (all asset) or a per-asset basis, if new or modified investment criteria is received.

In one example embodiment, the financial parameters for a given real estate asset are generated based, at least in part, on the processing of price history data associated with a set of real estate assets that satisfy criteria relative to one or more properties of the given real estate asset. In one example implementation, one or more financial parameters may be generated for a given real estate asset based on the processing of price history data for a set of real estate assets that satisfies location criteria. For example, the set of real estate assets may be those real estate assets that reside within a prescribed distance from the given real estate asset, or, for example, having the same zip code, or for example, residing within a common geographic region such as a town or county. It will be understood that a wide variety of location-based constraints may be employed to select a suitable set of real estate assets for processing.

In another example embodiment, the financial parameters for a given real estate asset are generated based, at least in part, on the processing of price history data associated with a set of real estate assets that satisfy similarity criteria relative to the given real estate asset. The similarity criteria may be multidimensional, for example, involving one or more dimensions such as location, price, population density, socio-economic measures, and hedonic measures. For example, a set of real estate assets that are similar to a given real estate asset may be determined by taking the set of 100 closest properties by Euclidean distance (using latitude and longitude transformed into Cartesian coordinates). Alternatively, the set of real estate assets that are similar to a given real estate asset may be determined by its urban or rural classification (based on whether or not 100 homes are within a one mile radius of the home). Additional examples of similarity criteria include, but are not limited to, urban density classification, economic activity classification (e.g. by size (˜GDP) or type (similar industries) or trend (growing/shrinking)), size (via square footage, same number of bed/bath), whether or not the properties lie in flood zone or not, and rental yield/cap rate.

In other example embodiments, the real estate assets may be classified according to a plurality of classification categories, and real estate information from different classification categories of real estate assets may be employed to generate category-specific financial parameters, and optionally, category-specific investment assessment measures. The predetermined category of each real estate asset may then be associated with a suitable category-specific investment assessment measure.

In one example embodiment of a classification-based calculation of financial parameters and associated investment measures, the real estate asset information database may be processed to determine, for each real estate asset, a density-based classification status. For example, a calculation may be performed for a given real estate asset to determine the number of homes within a given radius relative to the given real estate asset, and the number of homes may be employed to classify the given real estate asset. For example, if the real estate asset has at least 100 homes within a mile radius, then the given real estate asset is classified as urban, otherwise, it is classified as rural.

Having classified each real estate asset, the real estate information associated with real estate assets within each classification category can be processed to determine category-specific financial parameters. For example, within each classification category, calculations of holding period return may be performed for real estate assets having at least two transactions (both having a date and a price). A statistical measure such as average, or a weighted average (based on expected variance, which is roughly linear with time, and/or value weighted, based on the purchase price) may then be employed to generate an expected annual return by category. Alternatively, annual log returns may be used.

For example, classification may be performed according to three or more categories based on how many homes are within a mile radius (e.g. rural, suburban, urban). Additionally, the classification categories may be multidimensional, including such other classification dimensions as, for example, as number of bedrooms or geographic groupings, to further divide up the homes into distinct categories (groups). Furthermore, as described above, the classification may not be discrete, i.e. it may have a continuum of values such as square footage or purchase price. In such a case, average return could be regressed against the continuous variable, or a set of classification categories or bins (comprising values that lie within a certain range) may be created.

In one example embodiment, the results of the precomputations can be optimized for lookup speed by indexing the results (i.e. the data structure in which the results are stored) according to a unique identifier on a per-asset basis. For example, the long form address of a given real estate asset can be indexed to improve the lookup speed from linear time to logarithmic time (which can result in a lookup speed improvement by a factor of over a million for a property level database with one hundred million properties).

Referring now to FIG. 2B, a flow chart is provided that illustrates the processing steps involved in the rapid delivery of feedback associated with the pre-qualification of a potential real estate equity investment in response to a user query involving a selected real estate asset, based on the investment assessment measures that were precomputed according to the processing steps shown in FIG. 2A. The rapid feedback is facilitated by the capability of the server to quickly and efficiently identify, within the database of precomputed and stored investment assessment measures, the investment assessment measures associated with the user-selected real estate asset.

As shown by step 220, which is continued from FIG. 2A, the processing steps illustrated in FIG. 2B are performed after having precomputed and stored the investment assessment measures associated with the plurality of real estate assets according to the method shown in FIG. 2A. However, it will be understood that steps 230-260 may be performed in parallel, or in between, the subsequent updating of precomputed results (e.g. as per 225 in FIG. 2A).

In step 230 of FIG. 2B, the server receives a query from a remote computing device associated with a user, where the query identifies a selected real estate asset. For example, the query may identify the selected real estate asset based on location information, such as an address, or a set of latitude and longitude, or via other information that identifies or references a selected real estate asset (such as a user selecting, via user input, a location on a map). In one example implementation, a user may supply a unique property identifier through a form on a web or mobile application. This unique property identifier may be a long form address (i.e. “123 Main Street, San Francisco Calif., 94100”). The addresses may be cleaned via address cleaning software (such as the USPS API or SmartyStreets API).

The server then queries the database storing the investment assessment measures, as shown at 235, to determine whether or not one or more investment assessment measures associated with the selected real estate asset reside in the database. For example, referring to FIG. 1, the server 110 may query the real estate asset information database 120, in the event that the investment assessment measures are stored with the real estate asset information. Alternatively, the server may query an additional database, such as result database 125, in the event that the investment assessment measures are stored in a separate database, either of which may be integrated with, or separate from, the server 110.

In the event that the server determines that one or more investment assessment measures associated with the selected real estate asset reside in the database (i.e. have been precomputed and stored), as per outcome 250 of decision 240, the precomputed investment assessment measures associated with the selected real estate asset are obtained, as shown at step 252, and feedback associated with the one or more investment assessment measures is transmitted to the remote computing device, as shown at 260. As described above, this capability of providing rapid feedback to a user regarding an inquiry of a potential pre-approval of a real estate equity investment, based on precomputed investment assessment measures, solves the aforementioned technical problem by avoiding delays and costs associated with conventional pre-approval methods.

In some example embodiments, the user input that is received in step 230 may be validated prior to querying the database in step 235. For example, it can be assessed whether the address associated with the user input valid or missing important components, such as unit number for a condominium building or a directional street item (e.g. 100 N Grand Ave vs. 100 Grand Ave). In the case in which the address submitted is valid, it can be determined whether the components are accurate (i.e. not “fat-fingered”) by confirming, for example, whether the primary house number is actually associated with a real property, the street and city are spelled correctly, or the zip code is accurate for the identified street location. Checks for other extraneous data may also be conducted; this may include cases in which a unit number is offered for addresses in which it need not apply.

Furthermore, as shown in optional step 255, the one or more precomputed investment measures obtained from the database may be validated prior to generating and transmitting the feedback to the user in step 260. For example, there may be times in which specific property information underlying the investment assessment measures can be validated, or made more robust, by comparing data across multiple sources. Various external data sources can be used in conjunction with the data in step 200 and 202 of FIG. 2A. For example, geographic information can be confirmed by comparing the parsed, long-form address and/or geo-coordinates. Property attributes may also be “updated” by identifying data from a source that reflects property remodels or new construction or aggregated across sources in cases in which they disagree. For example, for discrete or categorical attributes, such as property type or number of bedrooms, the mode of the values across multiple sources can be taken as the true value. For more continuous variables, such as building square footage, a median or average value can be taken. For date values, such as “Last Sold Date” or “Year Built”, the oldest, most recent, or some aggregate value can be taken, depending on the impact of the variable. For example, an investment criteria may specify that “flipped-homes” (those recently purchased, remodeled, and often sold at a premium) are ineligible. In cases in which the “Last Sold Date” differs across sources, a conservative approach would be to use the most recent “Last Sold Date” when assessing this condition. The investment criteria could be evaluated with any new data to confirm the investment assessment measures.

Results from this validation may alter the investment assessment measures and/or feedback to the user. For example, if new information is presented that results in a violation of investment criteria, the resulting pre-qualification approval and/or offer may change.

In some example embodiments, the feedback that is transmitted in step 260 may be a direct transmission of the one or more investment assessment measures that were precomputed and stored, without further modification or processing of the investment assessment measures. For example, in the case in which the one or more precomputed investment assessment measures associated with a selected real estate is a binary indicator of pre-qualification (e.g. a “yes” or “no”), this information may be directly transmitted as feedback regarding the prequalification of the potential real estate equity investment. In other example embodiments, the feedback may be generated based on further processing of the stored investment assessment measures. Various non-limiting examples of different types of feedback are contemplated below, in the context of different categories of users of the system.

Referring again to FIG. 1, the users of the remote computing devices 100N may have different roles and relationships in a potential real estate equity investment involving a selected asset, and the feedback that is provided in response to a query may depend on the type of user. For example, as shown at 100A, one user may be an owner (or a prospective owner) of the selected real estate asset. In such an example use case, the homeowner may interact with the server to obtain feedback relating to pre-qualification, by one or more potential investors, of a potential real estate equity investment in the homeowner's home (or as an investment in a down payment on the purchase of a home by a prospective homeowner). As noted above, the feedback may take the form of a binary “yes” or “no” regarding pre-qualification. However, the feedback may additionally or alternatively include details regarding the potential real estate equity investment, such as proposed terms associated with the potential real estate equity investment, in the event that the selected real estate asset is prequalified. In another example implementation, the feedback may provide a mechanism by which the homeowner may contact an investor that has pre-qualified the homeowner, such as a click through to the investor's website, or information for contacting the investor.

In another example embodiment, in which multiple investment criteria are assessed and/or multiple investment opportunities can potentially be offered, the feedback may include one or more of these offers. For example, as explained above, multiple investment criteria can exist, and as a result, multiple offers, with different terms, can be returned to the user. In one example implementation, the “best” offer for the consumer (with the lowest price) may be shown, or shown first, or shown at the top of a list of offers, or visibly accented relative to other offers.

In some example embodiments, the end user's intention may be factored in. These intentions can be provided in the request, for example, by capturing input via a user interface in response to prompted questions, which can include, but is not limited to, asking how the potential customer plans to use the funds, for an estimate of their current mortgage balance or value of their home, and for personal information, such as age or gender. For example, a potential homebuyer may be looking for funds to help with a down payment on a home purchase. Alternatively, a current homeowner may be looking to sell equity or interest in their home for cash, either in a lump-sum format or via a stream of regular cash flows. The intentions of the user or customer may determine the investor criteria considered as the request is processed.

In another example use case illustrated in FIG. 1, as shown at 100B, the user may be an agent or other intermediary that operates between an investor and a homeowner (or potential homeowner). For example, the agent may be a real estate agent who employs the system to present options to a prospective homeowner for financing the purchase of a new home. In another example, the agent may be an investment advisor who employs the system to present, to a homeowner, opportunities for leveraging equity in their home to obtain cash through a real estate equity investment by an investor (who may be one or more third party investors). According to such example use cases, the feedback that is provided to the agent may include a confirmation for the buyer or seller of a listed real estate asset that it qualifies for one or more investment or financing opportunities. The buyer's or seller's real estate agent may use these results in a variety of ways to improve the home buying/selling process for their client. For example, the agent may generate listing collateral to better advertise the property to prospective buyers or use the results to create a more competitive offer for their buyer. The feedback could also indicate to an investment advisor that a client's home is eligible for one or more investment or financing opportunities. In some example embodiments, they may provide the agent an opportunity to offer new asset allocation and/or investment strategies to their client.

In another example use case, a financial advisor or other investment professional may employ the system to access the latest estimates of the financial parameters. For example, a financial advisor may obtain the expected return and expected volatility (systemic and idiosyncratic) in order to perform a portfolio optimization for the owner of the home with which the parameters are estimated for. In this case, the API may accept an address from the user and directly return the estimated expected return and volatility components, including their respective confidence bands and/or standard errors.

In another example use case illustrated in FIG. 1, the user may be an investor, as shown at 100C, and the investor may employ the system to assess whether or not specific real estate assets would be qualified according to investment criteria associated with the investor. In one example embodiment, the feedback could include estimates of the financial parameters associated with a specific real estate asset that, when processed according to the investor's own investment criteria, may create investment assessment measures used by the investor themselves, or offered to other clients.

Referring again to the decision step 240 in FIG. 2B, in the event that one or more investment assessment measures associated with the selected real estate asset do not reside in the database (i.e. they have not been precomputed as per the processing steps of FIG. 2A), then, as shown at step 245 in FIGS. 2B and 2C, steps 270-292 of FIG. 2C are performed. Accordingly, FIG. 2C illustrates the processing steps involved in the adaptive computation of an investment assessment measure associated with a selected real estate asset for which a precomputed investment assessment measure is not available, and the storing of the investment assessment measure to facilitate rapid delivery of feedback in the event of a future inquiry involving the selected real estate asset.

Steps 270-280 of FIG. 2C describe the processing steps that are performed, after having received the user query, in order to adaptively and dynamically (“on the fly”) generate one or more investment assessment measures associated with the selected real estate asset. In step 270, additional real estate asset information associated with the selected real estate asset is optionally obtained. For example, in the event that the user has provided incomplete or incorrect (e.g. due to typographical errors) information to identify the selected real estate asset, additional information may be sought, either from the user, or from an external data source. The additional real estate asset information pertaining to the selected real estate asset may further include information such as price history data and/or other types of data (described above, such as hedonic data) associated with the selected real estate asset. For example, additional attributes that may be provided include, but are not limited to, a number of bedroom, number of bathrooms, square footage of the lot, livable square footage, and listing price (if for sale).

In step 275, one or more financial parameters associated with the selected real estate asset are generated, for example, according to the methods described in the present disclosure. In example implementations in which additional real estate asset information associated with the selected real estate asset is obtained, as in step 270, the additional real estate asset information may be employed, at least in part, to generate the one or more financial parameters. The one or more financial parameters are then processed, as shown at step 280, according to investment criteria, in order to determine one or more investment assessment measures associated with the selected real estate asset, as per the example methods described elsewhere herein.

As shown at step 285, the investment assessment measures obtained for the selected real estate asset may optionally be validated prior to providing feedback to the remote computing device, for example, as described above with regard to step 255 of FIG. 2B. The validation performed in step 285 can be relatively more important in the event additional data is sourced from external sources in step 270, since, up to that point, minimal data may have been available to generate the financial parameters.

Having obtained and optionally validated the one or more investment assessment measures associated with the selected real estate, feedback regarding the pre-approval status of a potential real estate equity investment, generated based on the one or more investment assessment measures, is transmitted to the remote computing device, for example, as per the methods described above in relation to step 260 of FIG. 2B. However, in addition to providing the feedback, the one or more investment assessment measures, and also optionally the one or more financial parameters, are stored in association with the identity (e.g. location information) of the selected real estate asset. This information may be stored, for example, in the same database, and optionally in the same format, as the precomputed results generated according to the processing steps of FIG. 2A. This aspect of the present example embodiment therefore adaptively builds on the database of precomputed investment assessment measures, based on user query, adaptively and dynamically expanding the database coverage, and permitting the rapid delivery of feedback associated with potential pre-approval of real estate equity investments involving the selected real estate asset in the event of future queries.

As described above, the adaptive expansion of the database of precomputed investment assessment measures solves another aspect of the aforementioned technical problem, by ensuring that real-time processing of real estate information need not be performed for each selected real estate asset, whereby provided that the precomputed database of investment assessment measures provides coverage for the majority of real estate assets within a given geographic region (e.g. a country), most user queries associated with the given geographic region can be processed quickly and efficiently, without presenting an undue and latency-inducing burden of the processing capabilities of the server. This aspect of the present disclosure therefore provides a new processing modality that extends significantly beyond the conventional approach described above, and therefore provides a technical solution that lies outside of the status quo within the field of real estate investment that presently relies on per-asset investment opportunity assessment without precomputation.

Although the preceding example embodiments describe systems and methods in which investment assessment measures are precomputed, for each real estate asset, prior to receiving input from a user identifying a selected real estate asset, it will be understood that other example embodiments may involve the computation of one or more investment assessment measures after having received the user input identifying a selected real estate asset, such that the financial parameters are precomputed, but the one or more investment assessment measures are post-computed. This example embodiment may be beneficial, for example, in cases in which the calculation of the investment assessment measures, based on investment criteria, occurs on a faster timescale than the calculation of the respective financial parameters, and/or in cases in which the investor criteria changes, or is expected to change, on a timescale that is faster than the timescale for recalculation of the financial parameters due to updates to the real estate asset information.

The following illustrative and non-limiting example provides an example method of precomputing financial parameters and investment assessment measures for a plurality of real estate assets, and subsequently employing the precomputed investment assessment measures to provide rapid feedback in response to a query involving a potential real estate transaction involving a selected real estate asset.

According to the present example method, a discrete classification approach is employed to perform real estate classification and subsequent determination of category-based financial parameters. Three homes are identified having at least two transactions and having been classified as urban (i.e. they have at least 100 homes within a mile radius). Given the two transactions, holding period returns for these homes can be calculated as follows:
1. Home A: Purchased in 2000 for $1 mm and sold in 2001 for $1.2 mm->20% per year
2. Home B: Purchased in 2000 for $1 mm and sold in 2002 for $1.0 mm->0% per year
3. Home C: Purchased in 2000 for $1 mm and sold in 2001 for $1.1 mm->10% per year

One may therefore determine that urban homes return, on average, 10% per year. For the remainder of this illustrative example, it is assumed that a sample of rural homes is provided whose average annual return is 5% per year.

Having obtained estimates of the average return of homes by classification group, the average return of the other real estate assets in the database of real estate assets may be forecasted (e.g. homes that do not have at least two price history transactions).

Investment criteria (associated with one or more investors) may then be employed to determine investment assessment measures, which may then be employed for communicating pre-approval offers to homeowners. For example, an investor may prefer to invest in properties with a return of 7.5% per year. In this case, the server will store, based on this investment criteria, an investment assessment measure having a binary value for each home in the database based on whether or not the expected return will exceed 7.5% per year.

In the present simplified example, all of the homes that are classified as rural may be assigned values of 0 (for not investible) and 1 (for investible) for the investment assessment measures. However, instead of directly investing in the property, an investor may want to invest in a derivative financial asset associated with the property such as a call option on the value of the home, or a mortgage. In these cases, closed-form formulas, Monte Carlo or grid methods may be used to price these derivatives based on the estimated parameters of the homes (in this case the expected return). Additional market data may be helpful to improve these calculations, including risk-free interest rates. Furthermore, additional parameters such as expected variance and expected turnover may be computed using the data on homes with at least two transactions. Finally, correlation with other asset classes may be helpful for investors to determine what expected return required to make an investment attractive.

After having generated investment assessment measures for each real estate asset in the database, where the investment assessment measures include an associated binary value based on whether or not the expected return will exceed the investor required return, a user may quickly determine whether their home is qualified for investment by the investor by querying the database using a unique identifier as the lookup value, in this case a long form address.

In one example embodiment, a user may employ a web-app or mobile app and input a long form address of the property into a form. Upon user submission of the form, the long form address is cleaned, standardized and sent to the server via an application programming interface (API). The server performs a lookup using the long form address. Ideally, the database is indexed on the long form address to improve lookup speed. Once the property is found, a response is generated and sent back to the user via the API. The response is converted to a human readable message including whether or not an investment can be made on the home. For more than 80% of the homes in the database, a response can be generated within 30 seconds. Sometimes an exception process is initiated for a human to intervene and make a human decision. This typically takes a lot longer (on the order of several hours) for the user to receive a response.

If a property is not found in the database, the server will try to locate the property using at least one additional data source. This could occur because a home was recently built or because the data was simply never recorded. It will attempt to obtain the data required to make a decision from the at least one additional data source. In this case, the server needs a latitude and longitude to determine whether there are at least 100 homes in a square mile radius around the home. Google Maps can be used to obtain the latitude and longitude of the home. Google Maps provides an API in which geolocation information is provided in response to a request that includes a long form address input. Once the required data is obtained, the server can determine whether the home is urban or rural, generate an “on-the-fly” expected return, and therefore make an investment decision. This decision is then returned to the user via the API.

Alternatively, for data that is hard to find online, the server may request additional data about the house from a user. For instance, the number of bedrooms may be requested. Whether the server obtains the data from the user or another data source online, the data can be stored in the original database such that the database is continually growing and becoming more complete.

Although the present illustrative example employs only two classification categories (urban and rural), it will be understood that in other embodiments, more than two classification groups may be employed.

Furthermore, although the preceding examples were illustrated in the non-limiting and heuristic case of providing feedback associated with the pre-qualification of real estate equity investments, it will be understood that the systems and methods described herein may be employed to provide feedback based on a wide variety of different types of real estate transactions. For example, a non-limiting set of example transaction types include the following:
i. an equity purchase offer—a commitment by an investor to make an investment in the real estate property based on the information provided;
ii. an automated valuation or forecast—an estimate, for a real estate asset, of the valuation or forecast of returns, volatility and correlation to other assets;
iii. a purchase offer—an offer to purchase the real estate asset within a limited time for a given price; and
iv. a mortgage qualification—a commitment by a lender to originate a mortgage.

Examples of adapting the preceding method to facilitate the delivery of feedback associated with these example transactions are described below. In order to generate an automated valuation or forecast in response to a query involving a selected real estate asset, the preceding methods may be employed, with the exception that there is no investor or investment constraint to classify the real estate properties. Instead, the estimates of one or more of the financial parameters are stored for each unique real estate property in the list. Furthermore, in one example implementation, when a user submits an address to the API, they may receive an estimate of the one or more parameters. These parameters are an estimate of valuation, an expected long-run return, volatility, correlation and turnover rate.

In order to generate an automated purchase offer in response to a query involving a selected real estate asset, the preceding methods may be employed such that the investment assessment measures include an offer price (e.g. as opposed to a classification into an investible and non-investible set). An investor may provide investment criteria including risk and return constraints and an offer price that allows the investor to satisfy these constraints is generated as the purchase offer estimate. In this scenario, when a user submits an address to the API, they receive a purchase offer for an investment in the property when the criteria is satisfied. This example embodiment can be considered a variant of the aforementioned embodiment by considering the purchase of the property as the investment and considering a continuum of purchase prices as the set of investments to assess. For each purchase price, an IRR can be estimated and the highest price with which the expected IRR is satisfied for the investor will be the purchase offer provided to the end user.

In another example implementation, the feedback may be associated with a mortgage qualification or pre-qualification, and the feedback may include a pre-qualified mortgage rate. In such a case, the investment constrains are associated with the risk and reward profile of the investor. Similarly, this example embodiment can be considered a variant of the aforementioned embodiment by considering a mortgage on the property as the investment and a continuum of mortgage rates as the set of investments to assess. For each mortgage rate, an IRR can be estimated and the lowest rate with which the expected IRR is satisfied for the investor will be the mortgage origination offer provided to the end user.

Referring again to FIG. 1, the server 110 may include an application programming interface (API) which is instructed to, when receiving a query (request) from a remote computing device 100N on the network 130, transmit feedback such as, but not limited to, an equity purchase offer, an automated valuation, a purchase offer or a mortgage qualification to the computing device. The request comprises a unique identifier of the property in question. The server 110 uses this unique identifier to lookup the stored property and therefore the requested feedback (e.g. an equity purchase offer, automated valuation, purchase offer or mortgage qualification), and transmits the output over the network.

The API can be accessed by a remote user, for example, via a front-end webpage, web-app or mobile app hosted on a browser or application. The browser or application can be accessed by a user using a personal computer, laptop, tablet or smart phone. The front-end webpage, web-app or mobile app comprises a form to receive the unique property identifier, in this case an address of the property. The user can enter the unique property identifier into the form, then the webpage, web-app or mobile app parses the address, cleans and transforms the identifier into a format readable by the API. When the server 110 receives the property identifier and successfully generates an output, the server is instructed to return the result to the webpage, web-app or mobile app for display.

The API formats the address into a standardized format and passes the string along to the lookup server. The lookup server searches its records for a match on the standardized unique property address identifier. In the worst-case scenario, the server will have to search through every record, however if the server indexes the lookup table on the standardized unique property identifier, then the lookup speed can be improved to a worst-case number of lookups that is proportional to the natural logarithm of the number of entries. Since the number of unique properties in the United States is in the hundreds of millions, this improvement is substantial (100 million comparisons vs. 20 comparisons) and allows the round-trip response time from API request, to lookup, to API output to remain under 10 seconds (or under 5 seconds, or under 2 seconds, or under 1 second, depending on available computing resources and processing power).

As noted above, in the case where a homeowner or homebuyer is looking to qualify a property for a mortgage or equity financing solution (such as a home ownership investment), or get a property appraisal, quick turnaround time is critical. Securing a financing solution or assessing the correct value of a property is essential to produce a competitive bid.

In some example embodiments, as noted above, if the API receives an address which is not found in the list of unique real estate identifiers, the API can reply to the user via the API to request additional information pertaining to a selected real estate asset, such as, but not limited to, one or more of pricing and home transaction data, mortgage and other lien information, hedonic data, geolocation data, and homeowner data. In this scenario, the server may create a new property record in the database and subsequently estimates the one or more parameters, generates a financial output and responds to the user via the API. Since the new property characteristics, parameters and output are now stored in the database and the lookup list, the server can quickly respond with an output when a new user inputs the unique real estate identifier corresponding to the new property. This function allows the server to crowd source the generation of real estate data since new properties are created and renovated each year, and harvesting this data is expensive.

It is noted that the API is an optional layer between the user application. A user may pass the unique address identifier to the API or directly to the lookup server. The API may be beneficial in that it provides a level of security and consistency of behaviors from the user.

In some example embodiments, a first and second server may be established to separate the instructions to generate financial parameters and investment assessment measures from the instructions to receive, lookup and send the results via the API. The first server may be employed to process the heavy computation of estimating the financial parameters and optionally computing categorical values, which can be time consuming and requires a large amount of memory and processing power.

The second server may be employed to maintain an updateable copy of the list of unique real estate identifiers and their associated financial parameters, investment assessment measures, and classification/categorization status. Since real estate data does not change frequently, the stored results may only need to be updated once every week or month. Therefore, the second server can be employed to update the stored data once every week or month. However, API calls to return a precomputed feedback based on unique real estate identifiers can exceed hundreds or thousands of calls per day. Therefore, the second server may be optimized for high networks traffic and fast lookup speed. One such optimization is to index the list of real estate identifiers to improve lookup performance from a linear to logarithmic order of complexity.

In a different embodiment, users, or external automated systems, may directly submit queries to the API without an application. An API client can programmatically submit property addresses to receive decisions from API.

Referring again to FIG. 1, examples of remote computing devices include, but are not limited to, one or more asset owner computing devices 100A, one or more agent computing devices 1008, and one or more investor computing devices 100C. Each remote computing device 100N may include hardware and software for executing an application 105 presentable on a user interface, as described in detail below. In some example embodiments, the user of a remote computing device 100N can interact with the system through the application, providing input to select a given real estate asset, and receiving feedback associated with a potential investment in the selected real estate asset.

The network 130 can be a conventional type, wired or wireless, and may have numerous different configurations including a star configuration, token ring configuration or other configurations. Furthermore, the network 130 may include a local area network (LAN), a wide area network (WAN) (e.g., the Internet), and/or other interconnected data paths across which multiple devices may communicate. In some example implementations, the network 130 may be a peer-to-peer network. The network 130 may also be coupled to or include portions of a telecommunications network for sending data in a variety of different communication protocols. In some example implementations, the network 130 includes Bluetooth® communication networks or a cellular communications network for sending and receiving data including via short messaging service (SMS), multimedia messaging service (MMS), hypertext transfer protocol (HTTP), direct data connection, WAP, email, etc.

Although the server 110 is shown as a separate component relative to real estate asset information database 120, it will be understood that the server 110 may be directly or indirectly integrated with one or more databases, such as the real estate asset information database.

Remote computing device 100N may be a computing device that includes a memory and a processor, for example, a laptop computer, a desktop computer, a tablet computer, or a mobile telephone, other electronic device capable of accessing a network 130. In the illustrated implementation, each remote computing device 100N is communicatively coupled to the network 130 via a signal line (one or more portions of which may be wireless).

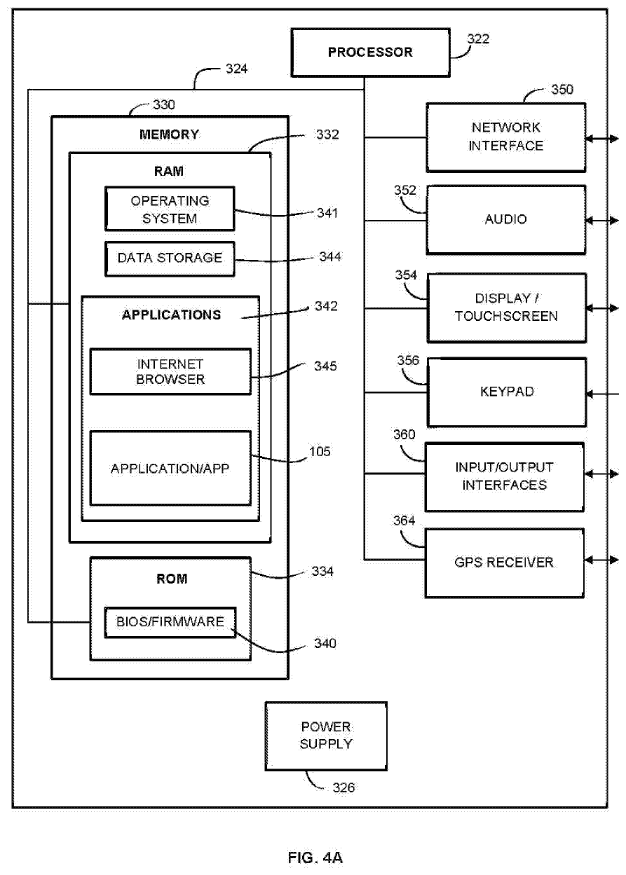

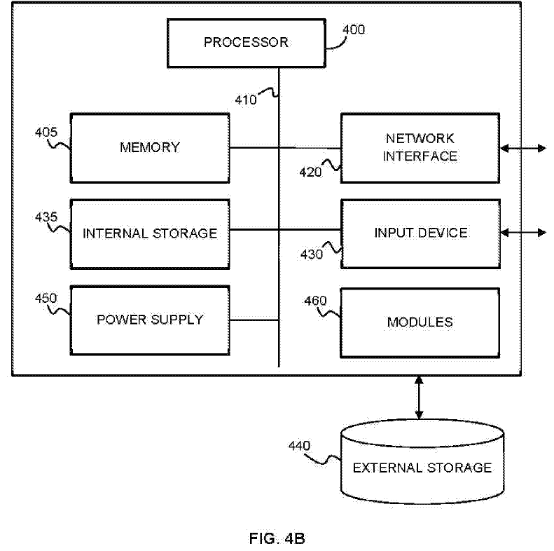

FIG. 4A illustrates an example embodiment of the computer hardware associated with remote computing device 100N. Remote computing device 100N includes a processor or processing unit (CPU) 322 in communication with a mass memory 330 via a bus 324. Remote computing device 100N also includes a power supply 326, one or more network interfaces 350, an optional audio interface 352, a display 354, an optional keypad 356, one or more input/output interfaces 360, and an optional global positioning systems (GPS) receiver 364. Power supply 326 provides power to remote computing device 100N. A rechargeable or non-rechargeable battery may be used to provide power. The power may also be provided by an external power source, such as an AC adapter or a powered docking cradle that supplements and/or recharges a battery.

The one or more processors 322 include an arithmetic logic unit, a microprocessor, a controller, or some other processor array to perform computations and/or provide electronic display signals to a display device (not shown). Processor 322 may be coupled to the bus 324 for communication with the other components of the computing device. Processor 322 may process data signals and may have various computing architectures including a complex instruction set computer (CISC) architecture, a reduced instruction set computer (RISC) architecture, or an architecture implementing a combination of instruction sets. Although only a single processor 322 is shown in FIG. 4A, multiple processors may be included and each processor may include a single processing core or multiple interconnected processing cores. Processor 322 may be capable of supporting the display of images and the capture and transmission of images, perform complex tasks, including various types of feature extraction and sampling, etc.

Example mass memory 330 includes a RAM 332, a ROM 334, and optically other storage means. Mass memory 330 illustrates another example of computer storage media for storage of information such as computer readable instructions, data structures, program modules or other data. Mass memory 330 stores a basic input/output system (“BIOS”) or firmware 340 for controlling low-level operation of remote computing device 100N. The mass memory also stores an operating system 341 for controlling the operation of remote computing device 100N. It will be appreciated that this component may include an operating system such as a version of Windows, Mac OS, UNIX, or LINUX™, or a specialized mobile client communication operating system such as iOS™, Android™, Windows Mobile™, or the Symbian® operating system, or an embedded operating system such as Windows CE. The operating system may include, or interface with a Java virtual machine module that enables control of hardware components and/or operating system operations via Java application programs.

Memory 330 further includes one or more data storage 344, which can be utilized by remote computing device 100N to store, among other things, applications 342 and/or other data. For example, data storage 344 may also be employed to store information that describes various capabilities of remote computing device 100N. The information may then be provided to another device based on any of a variety of events, including being sent as part of a header during a communication, sent upon request, or the like. Moreover, data storage 344 may also be employed to store personal information including but not limited to address lists, contact lists, personal preferences, or the like. In one embodiment, data storage 344 may be configured to store information, including, but not limited to user account information or the like. In one embodiment, a portion of the information may also be located remote to remote computing device 100N.

Although only one of each component is illustrated in FIG. 4A, any number of each component can be included in remote computing device 100N. For example, a computer typically contains a number of different data storage media. Furthermore, although bus 324 is depicted as a single connection between all of the components, it will be appreciated that the bus 324 may represent one or more circuits, devices or communication channels which link two or more of the components. For example, in personal computers, bus 324 often includes or is a motherboard.

Bus 324 can include a conventional communication bus for transferring data between components of a computing device or between computing devices, a network bus system including the network 130 or portions thereof, a processor mesh, a combination thereof, etc. In some implementations, any application and/or various software modules operating on remote computing device 100N (e.g., an operating system) may cooperate and communicate via a software communication mechanism implemented in association with the bus 324. The software communication mechanism can include and/or facilitate, for example, inter-process communication, local function or procedure calls, remote procedure calls, an object bus (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

Network interface 350 may include devices for communicating with other electronic devices. For example, the network interface 350 may include wireless network transceivers (e.g., Wi-Fi™, Bluetooth®, cellular), wired network interfaces (e.g., a CAT-type interface), USB, FireWire, or other known interfaces. Network interface 350 may provide connections to the network 130 and to other entities of the system using standard communication protocols including, for example, those discussed with reference to the network. Network interface 350 may link the processor 322 to the network 130, which may in turn be coupled to other processing systems. In the depicted implementation, network interface 350 is coupled to the network 130 via a signal line for communication and interaction with the other entities of the system.

In some example implementations, remote computing device 100N may be a mobile computing device. In such a case, remote computing device 100N may optionally communicate with a base station (not shown), or directly with another computing device. Network interface 350 of a mobile computing device may include circuitry for coupling remote computing device 100N to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra-wide band (UWB), IEEE 802.16 Worldwide Interoperability for Microwave Access (WiMax), SIP/RTP, Bluetooth®, infrared, Wi-Fi, Zigbee, or any of a variety of other wireless communication protocols. Network interface 350 is sometimes known as a transceiver, transceiving device, or network interface card (NIC) Display 354 may be a liquid crystal display (LCD), gas plasma, light emitting diode (LED), or any other type of display used with a computing device. Display 354 may also include a touch sensitive screen arranged to receive input from an object such as a stylus or a digit from a human hand. Remote computing device 100N may also include input/output interface 360 for communicating with external devices, such as a headset, or other input or output devices not shown in FIG. 4A. Input/output interface 360 can utilize one or more communication technologies, such as USB, infrared, Bluetooth®, Wi-Fi, Zigbee, or the like. Optional GPS transceiver 364 can determine the physical coordinates of remote computing device 100N on the surface of the Earth.

Applications or apps 342 include application 105 (shown in FIG. 1) and optionally third party applications. Such applications or “apps” 342 may include computer executable instructions which, when executed by remote computing device 100N, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth.

As described in detail above, application 105 may be configured to display, on a user interface of remote computing device 100N, one or more price quotes received from server 110, such that input can be received from the user for submitting one or more orders to server 110. In some example implementations, application 105 acts, in part, as a thin-client application that may be stored on the remote computing devices 100N, and in part as components that may be stored on one or more of the servers.

Some aspects of the present disclosure can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version. Alternatively, the logic to perform the processes as discussed above could be implemented in additional computer and/or machine readable media, such as discrete hardware components as large-scale integrated circuits (LSI's), application-specific integrated circuits (ASIC's), or firmware such as electrically erasable programmable read-only memory (EEPROM's) and field-programmable gate arrays (FPGAs).

Embodiments of the disclosure can be implemented via the microprocessor(s) and/or the memory. For example, the functionalities described above can be partially implemented via hardware logic in the microprocessor(s) and partially using the instructions stored in the memory. Some embodiments are implemented using the microprocessor(s) without additional instructions stored in the memory. Some embodiments are implemented using the instructions stored in the memory for execution by one or more microprocessor(s). Thus, the disclosure is not limited to a specific configuration of hardware and/or software. It is noted, however, that for both the server and the remote computing devices, the inclusion of modules for the processing and execution of instructions associated with the processing methods described above transforms an otherwise general-purpose computing device into a specialty-purpose computing device.

Server 110 may include one or more computing devices having one or more processors, and one or more storage devices for storing data or instructions for execution by the one or more processors. For example, a computing device may be a hardware server, a server array or any other computing device, or group of computing devices, having data processing, storing and communication capabilities. A computing device may also be a virtual server (e.g., a virtual machine) implemented via software. For example, the virtual server may operate in a host server environment and access the physical hardware of the host server including, for example, a processor, memory, storage, network interfaces, etc., via an abstraction layer (e.g., a virtual machine manager).

Referring to FIG. 4B, server 110 may be any suitable computing device, such as a personal computer, rack-mounted computing equipment, or a specialty purpose computing device. FIG. 4B illustrates one example implementation of a server 110, including hardware such as a processor 400, memory 405, bus 410, network interface 420, input device 430, internal storage 435, optional external storage device 440 (e.g. a database server for storing the real estate asset information, or the precomputed results), and power supply 450. As noted above, the server 110 may be configured as a web server having an API. Modules 460, such as modules 112, 114 and 116 of FIG. 1, are stored as computer-readable instructions in memory 405 and executed by processor 400.

While some embodiments can be implemented in fully functioning computers and computer systems, various embodiments are capable of being distributed as a computing product in a variety of forms and are capable of being applied regardless of the particular type of machine or computer readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

A computer readable storage medium can be used to store software and data which when executed by a data processing system causes the system to perform various methods. The executable software and data may be stored in various places including for example ROM, volatile RAM, nonvolatile memory and/or cache. Portions of this software and/or data may be stored in any one of these storage devices. As used herein, the phrases “computer readable material” and “computer readable storage medium” refers to all computer-readable media, except for a transitory propagating signal per se.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A system for providing automated rapid feedback pertaining to potential real estate transactions, the system comprising:
a server comprising memory coupled with one or more processors to store instructions, which when executed by the one or more processors, causes the one or more processors to generate and store automated real estate investment opportunity assessment measures by performing operations comprising:
obtaining real estate asset information associated with a plurality of real estate assets, the real estate asset information comprising location information respectively associated with each real estate asset of the plurality of real estate assets, the real estate asset information further comprising price history data respectively associated with each real estate asset of at least a portion of the plurality of real estate assets;
processing the real estate asset information to determine, for each real estate asset, one or more financial parameters comprising an estimated return; and
for each real estate asset, processing the financial parameters according to investment criteria to generate an investment assessment measure associated with a potential real estate transaction, and storing the investment assessment measure in association with the real estate asset in a database;
the server being further configured to provide automated and low-latency feedback regarding a potential real estate transaction in a selected real estate asset by performing operations comprising:
receiving, from a remote computing device, input identifying the selected real estate asset;
querying the database to determine whether or not the database includes an investment assessment measure associated with the selected real estate asset;
in the event that the database includes an investment assessment measure associated with the selected real estate asset:
transmitting, to the remote computing device, feedback based on the investment assessment measure, thereby providing rapid feedback of a potential real estate transaction associated with the selected real estate asset; and
in the event that the database omits an investment assessment measure associated with the selected real estate asset:
processing the real estate asset information to determine, for the selected real estate asset, one or more financial parameters comprising an estimated return;
processing the one or more financial parameters associated with the selected real estate asset according to the investment criteria to generate an investment assessment measure associated with a potential real estate transaction in the selected real estate asset;
transmitting, to the remote computing device, feedback based on the investment assessment measure, thereby providing feedback of the potential real estate transaction associated with the selected real estate asset; and
storing the investment assessment measure in association with the selected real estate asset in the database to enable rapid feedback during subsequent queries associated with the selected real estate asset.

2. The system according to claim 1 wherein the server is configured to process the real estate asset information to determine the one or more financial parameters respectively associated with each real estate asset by:
processing the real estate asset information to generate, for each real estate asset, a classification score based at least on a calculated local density of real estate assets associated with the real estate asset;
for at least a portion of the real estate assets having price history data respectively associated therewith, employing the respective price history data and the respective classification scores to determine a relationship between each financial parameter and classification score; and
for each real estate asset, calculating each financial parameter of the one or more financial parameters based on the respective classification score and the relationship between the financial parameter and classification score.

3. The system according to claim 2 wherein the server is configured such that the classification score is employed to classify each asset among a plurality of classification bins, and wherein the relationship between each financial parameter and the classification score is determined based on a statistical measure associated with the distribution of financial parameter values within each classification bin.

4. The system according to claim 3 wherein the server is configured such that the classification bins are associated with different ranges of local density of real estate assets.

5. The system according to claim 2 wherein the server is configured such that in the event that the database omits the investment assessment measure associated with the selected real estate asset, the one or more financial parameters associated with the selected real estate asset are obtained by:
processing the real estate asset information to generate, for the selected real estate asset, a classification score based at least on a calculated local density of real estate assets associated with the selected real estate asset; and
calculating each financial parameter of the one or more financial parameters for the selected real estate asset based on the classification score of the selected real estate asset and the relationship between the financial parameter and classification score.

6. The system according to claim 5 wherein additional real estate asset information associated with the selected real estate asset is obtained and processed when determining the classification score of the selected real estate asset.

7. The system according to claim 1 wherein the server is configured to process the real estate asset information to determine the one or more financial parameters for each given real estate asset of at least a subset of the real estate assets by:
obtaining price history data from a set of regional real estate assets that satisfy location criteria involving the location information associated with the given real estate asset; and
processing the price history data to generate the one or more financial parameters.

8. The system according to claim 7 wherein the server is configured such that in the event that the database omits the investment assessment measure associated with the selected real estate asset, the one or more financial parameters associated with the selected real estate asset are obtained by:
obtaining price history data from a set of regional real estate assets that satisfy location criteria involving the location of the selected real estate asset; and
processing the price history data to generate one or more financial parameters associated with the selected real estate asset.

9. The system according to claim 8 wherein additional real estate asset information associated with the selected real estate asset is obtained and processed to determine the one or more financial parameters associated with the selected real estate asset.

10. The system according to claim 1 wherein the server is configured to process the real estate asset information to determine the one or more financial parameters for each given real estate asset of at least a subset of the real estate assets by:
processing the real estate asset information to determine a set of similar real estate assets satisfying similarity criteria associated with the given real estate asset, wherein each real estate asset of the set of similar real estate assets has price history data respectively associated therewith; and
processing the price history data associated with the set of similar real estate assets to generate the one or more financial parameters.

11. The system according to claim 10 wherein the server is configured such that in the event that the database omits the investment assessment measure associated with the selected real estate asset, the one or more financial parameters associated with the selected real estate asset are obtained by:
obtaining price history data from a set of real estate assets satisfying the similarity criteria associated with the selected real estate asset;
processing the price history data to generate one or more financial parameters associated with the selected real estate asset.

12. The system according to claim 11 wherein additional real estate asset information associated with the selected real estate asset is obtained and processed to determine the one or more financial parameters associated with the selected real estate asset.

13. The system according to claim 1 wherein the server is configured such that the real estate asset information further comprises hedonic information associated with least one real estate asset of the plurality of real estate assets, and wherein the server is configured to process the hedonic information in addition to the price history data when generating the one or more financial parameters for at least one real estate asset having hedonic information associated therewith.

14. The system according to claim 1 wherein the server is configured such that the real estate asset information further comprises lien information associated with least one real estate asset of the plurality of real estate assets, and wherein the server is configured to process the lien information in addition to the price history data when generating the one or more financial parameters for at least one real estate asset having lien information associated therewith.

15. The system according to claim 1 wherein the server is configured such that the real estate asset information further comprises homeowner financial information associated with least one real estate asset of the plurality of real estate assets, and wherein the server is configured to process the homeowner financial information in addition to the price history data when generating the one or more financial parameters for at least one real estate asset having homeowner financial information associated therewith.

16. The system according to claim 1 wherein the server is configured to process location-specific economic information in addition to the price history data when generating the one or more financial parameters for at least one real estate asset.

17. The system according to claim 1 wherein the server is configured to validate the investment assessment measure prior to transmitting the feedback to the remote computing device.

18. The system according to claim 17 wherein the server is configured such that the investment assessment measure is validated by processing additional asset information associated with the selected real estate asset, wherein the additional asset information is obtained from a third-party source.

19.-30. (canceled)

31. The system according to claim 1 wherein the server is configured such that the real estate asset information and the investment assessment measures are stored in separate databases.

32. (canceled)

33. A system for providing automated rapid feedback pertaining to potential real estate transactions, the system comprising:
a server comprising memory coupled with one or more processors to store instructions, which when executed by the one or more processors, causes the one or more processors to generate and store financial parameters associated with real estate assets by performing operations comprising:
obtaining real estate asset information associated with a plurality of real estate assets, the real estate asset information comprising location information respectively associated with each real estate asset of the plurality of real estate assets, the real estate asset information further comprising price history data respectively associated with each real estate asset of at least a portion of the plurality of real estate assets;
processing the real estate asset information to determine, for each real estate asset, one or more financial parameters comprising an estimated return, and storing the one or more financial parameters in a database;
the server being further configured to provide automated and low-latency feedback regarding a potential real estate transaction in a selected real estate asset by performing operations comprising:
receiving, from a remote computing device, input identifying the selected real estate asset;
querying the database to determine whether or not the database includes one or more financial parameters associated with the selected real estate asset;
in the event that the database includes one or more financial parameters associated with the selected real estate asset:
processing the financial parameters associated with the selected property according to investment criteria to generate an investment assessment measure associated with a potential real estate transaction in the selected real estate asset;
storing the investment assessment measure in association with the selected real estate asset;
transmitting, to the remote computing device, feedback based on the investment assessment measure, thereby providing rapid feedback of a potential real estate transaction associated with the selected real estate asset; and
in the event that the database omits an investment assessment measure associated with the selected real estate asset:
processing the real estate asset information to determine, for the selected real estate asset, one or more financial parameters comprising an estimated return;
processing the one or more financial parameters associated with the selected real estate asset according to the investment criteria to generate an investment assessment measure associated with a potential real estate transaction in the selected real estate asset;
transmitting, to the remote computing device, feedback based on the investment assessment measure, thereby providing feedback of the potential real estate transaction associated with the selected real estate asset; and
storing the investment assessment measure in association with the selected real estate asset in the database to enable rapid feedback during subsequent queries associated with the selected real estate asset.

34.-36. (canceled)
